(19) United States
(12) Patent Application Publication
(10) Pub. No.: US 2026/0307429 A1
(43) Pub. Date: Oct. 8, 2026

(54) COVER FOR A PAIL

(71) Applicant: David R. Hamilton, Carolina Shores, NC (US)

(72) Inventor: David R. Hamilton, Carolina Shores, NC (US)

(21) Appl. No.: 19/170,216

(22) Filed: Apr. 4, 2025

(51) Int. Cl. B44D 3/12

(52) U.S. Cl. CPC B44D 3/127

(57) ABSTRACT

A cover adapted and configured to be detachably coupled to the top of a pail, particularly, a hand-held paint pail.

### I. RELATED APPLICATIONS

There are no currently pending applications anywhere in the world.

### II. FIELD OF THE INVENTION

The present application discloses and describes a cover for a pail, and more particularly, a cover being sized, shaped, and configured to snugly engage and conform to the shape and contour of the lip of a hand-held pail.

### III. BACKGROUND OF THE INVENTION

A number of various covers for containers, such as paint containers, are disclosed in the prior art. Although not an exhaustive itemization of those efforts, the following is a representation of the various devices and systems that have been developed:
U.S. Pat. No. 12,168,551B2, issued in the name of van de Liefvoort et al. ;
U.S. Pat. No. 2,609,119, issued in the name of Shilstone;
U.S. Pat. No. 5,004,118, issued in the name of England et al. ;
U.S. Pat. No. 5,305,909, issued in the name of Merritt;
U.S. Patent Publication No. 2012/0024873A1, published in the name of Roseblade et al.; and
U.S. Pat. No. 3,727,793, issued in the name of Staubly.

Accordingly, there is a need for a cover being sized, shaped, and configured to snugly engage and conform to the shape and contour of the lip of a hand-held pail.

This application presents claims and embodiments that fulfill a need or needs not yet satisfied by the products, inventions, systems, and methods previously or presently available. In particular, the claims and embodiments disclosed herein describe a cover for a pail, the cover comprises a flexible, water impermeable or water-repellent, durable body, the body comprises an interior surface, an exterior surface, and a peripheral edge forming a loop about the entire peripheral edge, wherein the loop securely encloses an elastic member; a flexible, hygroscopic liner removably attached to the interior surface of the body; and a coupling means for removably attaching the hygroscopic liner to the interior surface of the body, the cover providing unanticipated and nonobvious combination of features distinguished from the products, devices, apparatuses, inventions, systems, and methods preexisting in the art. The applicant is unaware of any device, apparatus, method, system disclosure or reference that discloses the features of the claims and embodiments disclosed herein.

### IV. SUMMARY OF THE INVENTION

Generally, according to a broadly described embodiment, a cover for a pail is disclosed. The cover comprises a flexible, water impermeable or water-repellent, durable body, wherein the body is adapted and configured to snugly engage and conform to the shape and contour of the lip of the pail, and wherein the body extends around the entire lip of the pail, thereby detachably coupling the cover to the top of the pail.

The body comprises a peripheral edge forming a loop about the entire peripheral edge, wherein the loop securely encloses an elastic member, such as an elastic band.

The cover further comprises a flexible, hygroscopic liner removably attached to the interior surface of the body.

In accordance to another embodiment, the cover comprises a hole defined through a section of the body, proximate an upper margin of the elastic band. The hole allows for a handle of a painting implement, such as a paint brush or paint roller, to extend through the hole when the painting implement is placed in a pail containing wet paint and the cover is detachably coupled to the top of the pail. In the event a painting implement is not positioned within the pail, the hole may be closed or otherwise covered via an integrated flap.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a perspective view of a cover for a hand-held pail, in accordance to one embodiment of the present invention;

FIG. 2 is a bottom plan view of the container of FIG. 1;

FIG. 3 is a bottom plan view of a cover for a hand-held pail, in accordance to another embodiment of the present invention;

FIG. 4 illustrates a conventional hand-held pail;

FIG. 5 illustrates another conventional hand-held pail;

FIG. 6 is a bottom plan view of the cover illustrating a hygroscopic liner, in accordance to one embodiment of the present invention;

FIG. 7 is a bottom plan view of the cover illustrating a hygroscopic liner, in accordance to another embodiment of the present invention;

FIG. 8 is a bottom plan view of the body of the cover illustrating a coupling means for detachably coupling a hygroscopic liner thereto, in accordance to one embodiment of the present invention;

FIG. 9 is top plan view of a hygroscopic liner, in accordance to one embodiment of the present invention;

FIG. 10 is a bottom plan view of the hygroscopic liner of FIG. 9;

FIG. 11 is a side elevational view of the cover shown detachably coupled to the top of a pail, in accordance to one embodiment of the present invention;

FIG. 12 is a side elevational view of a cover for a hand-held pail, in accordance to an alternate embodiment of the present invention;

FIG. 13 is a perspective view of a painting implement; and

FIG. 14 is a perspective view of another painting implement.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

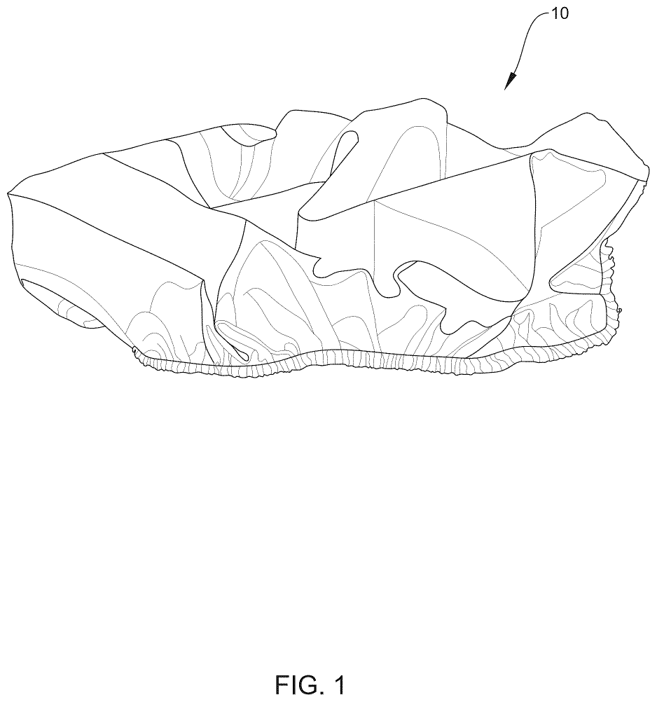

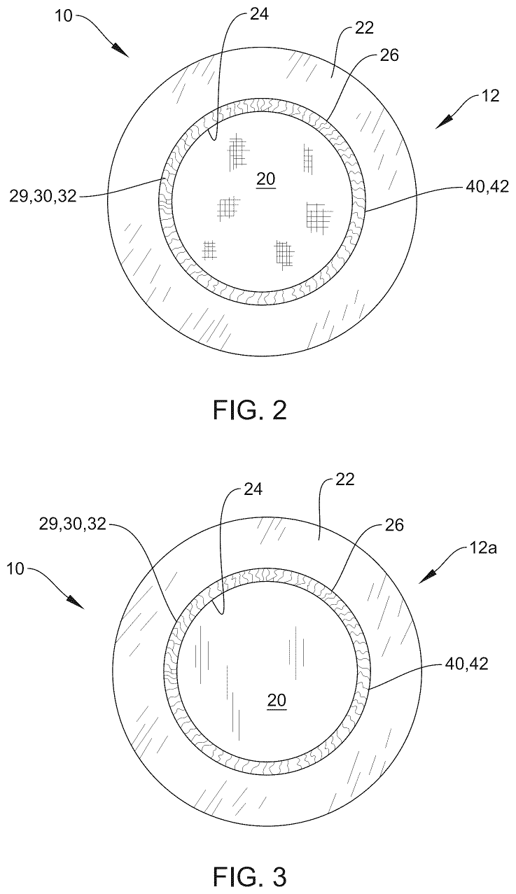

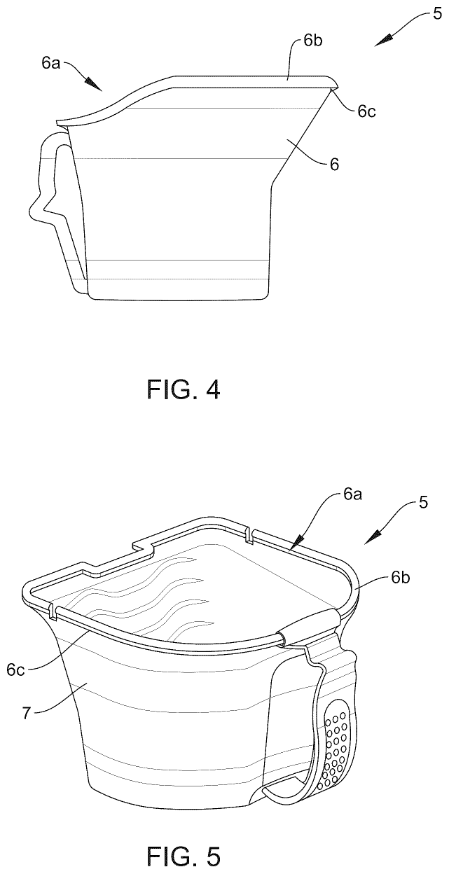

According to at least one embodiment, and consistent with FIGS. 1 and 2, a cover for a pail is generally denoted by the reference character 10. Consistent with the figures, the cover for a pail 10, hereinafter, “cover 10”, is sized, shaped, and configured to snugly engage and conform to the shape and contour of a lip 6a of a pail 5, such as a conventional hand-held pail 6 and 7, depicted in FIGS. 4 and 5. For purposes of this disclosure, the terms “snug”, “snugly”, and “snug-fit” are each defined as a substantially-intimate, close-fitting relationship. As depicted in the figures, exemplary pails 6 and 7 each comprises an open top 6a having a continuous, convex curved lip 6b which terminates at an interface 6c.

In accordance to a preferred embodiment, the cover 10 comprises a flexible, water impermeable, durable body 12, wherein the body 12 is adapted and configured to snugly engage and conform to the shape and contour of the lip 6a of the pail 6, the body 12 extending around the entire lip 6a of the pail 6, thereby detachably coupling the cover 10 to the top 6a of the pail 6. The cover 10 comprises a generally circular configuration; however, other geometric shapes are envisioned, such as including, but not limited to, oval, square, and rectangular.

Referring now to FIG. 3, and in accordance to another embodiment, the cover 10 comprises a flexible, water-repellent, durable body 12a, wherein the body 12a is adapted and configured to snugly engage and conform to the shape and contour of the lip 6a of the pail 6, the body 12a extending around the entire lip of the pail 6. The body 12, 12a may be constructed from a material selected from the group which includes, but is not limited to, nylon woven with polymer fibers, polyester woven with polymer fibers, vinyl, merino wool, extra-long staple woven cotton, polytetrafluoroethylene, polyurethane laminated fabric, thermoplastic polyurethane fabric, and latex fabric.

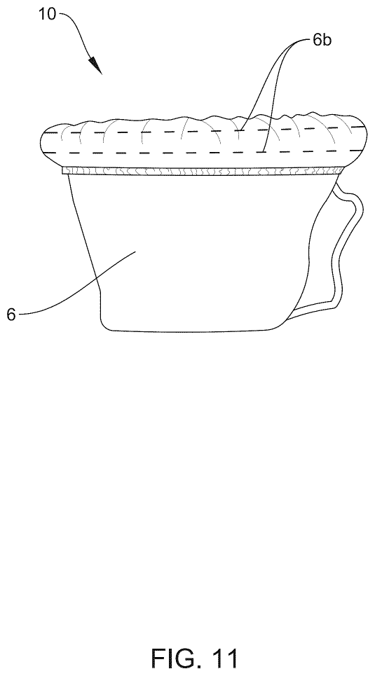

Referring now more particularly to FIGS. 1-5, the body 12, 12a comprises an interior surface 20 and an exterior surface 22. The body 12, 12a further comprises a peripheral edge 24 forming a loop 26 about the entire peripheral edge 24, wherein the loop 26 securely encloses an elastic member 30, such as an elastic band 32, via a suitable attachment means 40, such as including, but not limited to, stitching 42 and thermal bonding. The peripheral edge 24 of the body 12, 12a of cover 10 is stretched and placed over the top 6a of the pail 6, extending the peripheral edge 24 stretchably over the lip 6b of the pail 6 and below the interface 6c thereof. The elastic band 32 contracts, thus securely holding the cover 12, 12a in place on the top 6a of the pail 6, as depicted in FIG. 11.

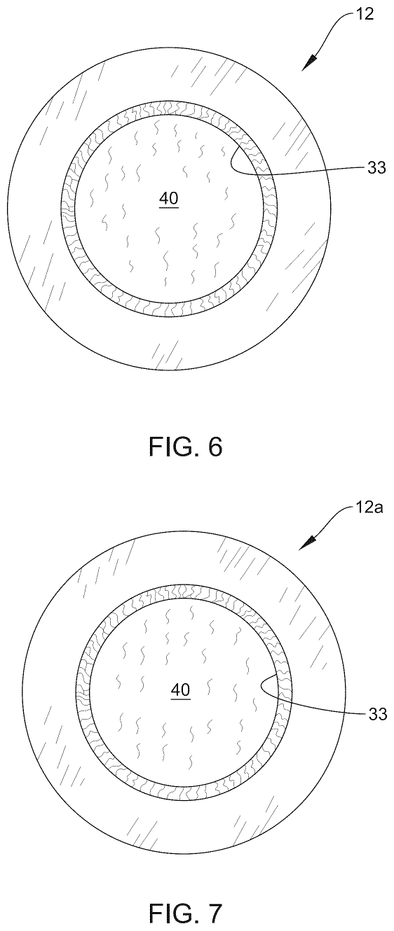

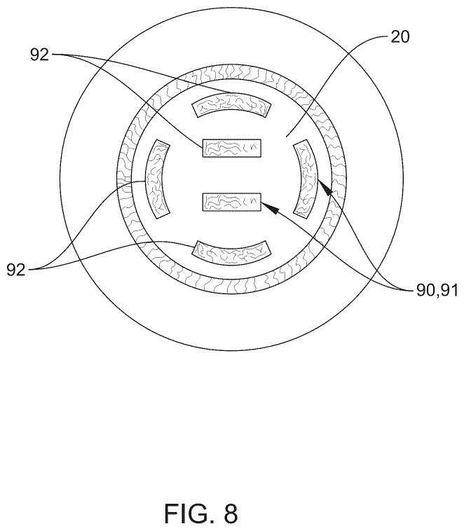

Referring now to FIGS. 6-10, the body 12, 12a further comprises a flexible, hygroscopic liner 40 removably attached to the interior surface 20 of the body 12, 12a. The hygroscopic liner 40 is sized so as to overlap the interior surface 20, abutting the upper margin 33 of the elastic band 32. The hygroscopic liner 40 includes an upper surface 42 opposing a lower surface 44. The hygroscopic liner 40 may be constructed of a material selected from the group which includes, but is not limited to, cotton, wool, linen, bamboo, viscose, rayon, hemp, and blends thereof.

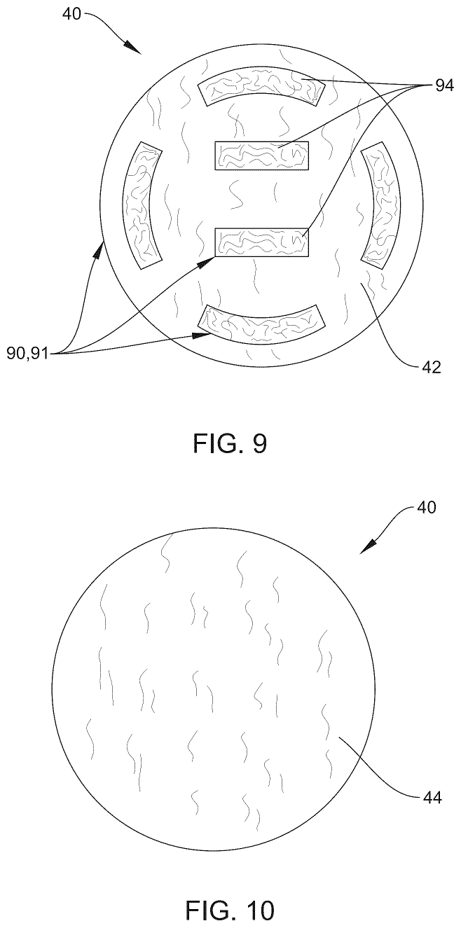

The liner 40 removably attached to the interior surface 20 of the body 12, 12a via a coupling means 90. In accordance to one embodiment, the coupling means 90 comprises a coupling element 92 spatially disposed on the interior surface 20 of the body 12, 12a and a complementary coupling element 94 spatially disposed on the upper surface 42 of the hygroscopic liner 40, as best illustrated in FIGS. 8 and 9, respectively. Accordingly, coupling means 90 mutually couples the liner 40 to the body 12, 12a through the conjoining and/or coupling of complementary elements 92 and 44 selected for use as the coupling means 90.

Thus, the coupling means 90 is utilized for detachably coupling the liner 40 to the interior surface 20 of the body 12, 12a, and is achieved using one or more coupling elements 92 and 94. These coupling elements 92 and 94 may include, singularly or in combination, hook-and-loop fasteners, buttons, studs, toggles, eyelets, buckles, zippers, snap fasteners, magnets, grommets, and other complementary type or matching connector devices and systems.

In accordance to one embodiment shown in FIGS. 8-10, the coupling means 90 comprises hook-and-loop fastener material 91, wherein the hook portion 92 thereof is spatially disposed on the interior surface 20 of the body 12, 12a, and the loop portion 94 thereof is spatially disposed on the upper surface 42 of the liner 40, or vice-versa.

In accordance to another embodiment, the coupling means 90 may comprise a suitable adhesive.

In order to hydrate the hygroscopic liner 40, water is sprayed directly onto the lower surface 44 of the liner 40 as a mist until the liner 40 is saturated with the water. The water may be sprayed onto the liner 40 prior to or after detachably coupling the liner 40 to the interior surface 20 of the body 12, 12a.

The cover 10 imparts important, unanticipated and nonobvious functional utility to the present invention. Once the cover 10 is detachably coupled to the top 6a of the pail 6 or 7, the cover 10 prevents the paint (not shown) contained within the pail 6 or 7 from drying out for a period of approximately 36-60 hours.

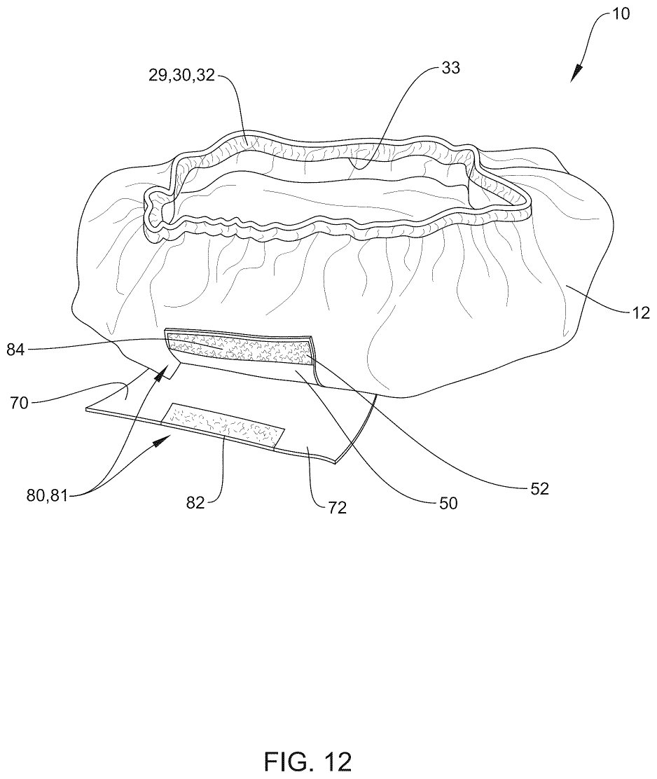

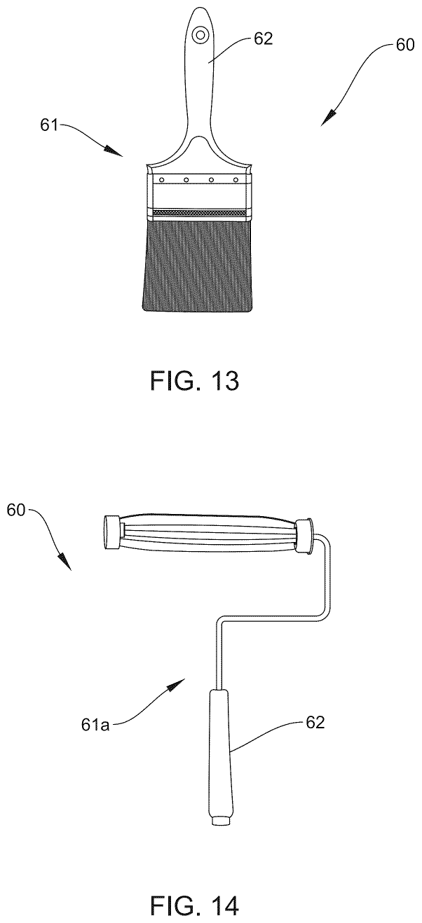

Finally, in reference to FIGS. 12-14, and in accordance to one alternate embodiment, a hole 50 may be defined through a section of the body 12, proximate the upper margin 33 of the elastic band 32. The hole 50 may comprise any one of a number of geometric shapes, such as including, but not limited to, circular, oval, square, and rectangular. The hole 50 allows for a handle 62 of a painting implement 60, such as a paint brush 61 or paint roller 61a, to extend through the hole 50 when the painting implement 60 is placed in a pail 6 containing wet paint and the cover 10 is detachably coupled to the top 6a of the pail 6. In the event a painting implement 60 is not positioned within the pail 6, the hole 50 may be closed or otherwise covered via an integrated flap 70. A lower end 72 of the flap 70 is removably attachable to an apron 52 of the hole 50 via a coupling means 80, thereby allowing the hole 50 to be selectively opened and closed (or covered) via the flap 70 by the user.

In accordance to one embodiment, the coupling means 80 comprises a coupling element 82 disposed on a lower surface 72 of the flap 70 and a complementary coupling element 84 disposed on the apron 52 of the hole 50, as illustrated in FIG. 12. Accordingly, coupling means 80 mutually couples the flap 70 to the apron 52 of the hole 50 through the conjoining and/or coupling of complementary elements 82 and 84 selected for use as the coupling means 80.

Thus, the coupling means 80 is utilized for detachably coupling the flap 70 to the apron 52 of the hole 50, and is achieved using one or more coupling elements 82 and 84. These coupling elements 82 and 84 may include, singularly or in combination, hook-and-loop fasteners, buttons, studs, toggles, eyelets, buckles, zippers, snap fasteners, magnets, grommets, and other complementary type or matching connector devices and systems.

In accordance to one embodiment depicted in FIG. 12, the coupling means 80 comprises hook-and-loop fastener material 81, wherein the hook portion 82 thereof is disposed on the lower surface 72 of the flap 70 and the loop portion 84 thereof is disposed on the apron 52 of the hole 50, or vice-versa.

In accordance to another embodiment, the coupling means 80 may comprise a suitable adhesive.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A cover for a pail, the cover comprises:
a flexible, water impermeable, durable body, the body comprises an interior surface, an exterior surface, and a peripheral edge forming a loop about the entire peripheral edge, wherein the loop securely encloses an elastic member;
a flexible, hygroscopic liner removably attached to the interior surface of the body, the hygroscopic liner includes an upper surface opposing a lower surface, and
a coupling means, the coupling means removably attaches the hygroscopic liner to the interior surface of the body.

2. The cover of claim 1, wherein the hygroscopic liner is sized so as to overlap the interior surface of the body, abutting an upper margin of the elastic member.

3. The cover of claim 2, wherein the coupling means comprises a coupling element spatially disposed on the interior surface of the body and a complementary coupling element spatially disposed on the upper surface of the hygroscopic liner.

4. The cover of claim 3, wherein the coupling means mutually couples the hygroscopic liner to the body through the conjoining or coupling of the coupling element and the complementary coupling element.

5. The cover of claim 4, wherein the body snugly engages and conforms to a shape and contour of a lip of the pail, the body extending around the entire lip of the pail, thereby detachably coupling the cover to a top of the pail.

6. A cover for a pail, the cover comprises:
a flexible, water-repellent, durable body, the body comprises an interior surface, an exterior surface, and a peripheral edge forming a loop about the entire peripheral edge, wherein the loop securely encloses an elastic member;
a flexible, hygroscopic liner removably attached to the interior surface of the body, the hygroscopic liner includes an upper surface opposing a lower surface, and
a coupling means, the coupling means removably attaches the hygroscopic liner to the interior surface of the body.

7. The cover of claim 6, wherein the hygroscopic liner is sized so as to overlap the interior surface of the body, abutting an upper margin of the elastic member.

8. The cover of claim 7, wherein the coupling means comprises a coupling element spatially disposed on the interior surface of the body and a complementary coupling element spatially disposed on the upper surface of the hygroscopic liner.

9. The cover of claim 8, wherein the coupling means mutually couples the hygroscopic liner to the body through the conjoining or coupling of the coupling element and the complementary coupling element.

10. The cover of claim 9, wherein the body snugly engages and conforms to a shape and contour of a lip of the pail, the body extending around the entire lip of the pail, thereby detachably coupling the cover to a top of the pail.

11. A cover for a pail, the cover comprises:
a flexible, water-repellent, durable body, the body comprises:
an interior surface;
an exterior surface;
a peripheral edge forming a loop about the entire peripheral edge, wherein the loop securely encloses an elastic member; and
a hole defined through a section of the body, proximate an upper margin of the elastic member;
a flap integrated with the body, the flap enabling opening and closing or covering of the hole;
a flexible, hygroscopic liner removably attached to the interior surface of the body, the hygroscopic liner includes an upper surface opposing a lower surface, and
a coupling means, the coupling means removably attaches the hygroscopic liner to the interior surface of the body.

12. The cover of claim 11, wherein the hygroscopic liner is sized so as to overlap the interior surface of the body, abutting an upper margin of the elastic member.

13. The cover of claim 12, wherein the coupling means comprises a coupling element spatially disposed on the interior surface of the body and a complementary coupling element spatially disposed on the upper surface of the hygroscopic liner.

14. The cover of claim 13, wherein the coupling means mutually couples the hygroscopic liner to the body through the conjoining or coupling of the coupling element and the complementary coupling element.

15. The cover of claim 14, wherein the body snugly engages and conforms to a shape and contour of a lip of the pail, the body extending around the entire lip of the pail, thereby detachably coupling the cover to a top of the pail.
